(19) United States
(12) Patent Application Publication
(10) Pub. No.: US 2004/0061941 A1
(43) Pub. Date: Apr. 1, 2004

(54) Optical grating writing system

(76) Inventors: Dmitrii Yu Stepanov, Croydon Park (AU); Igor Anikeev, Glenunga (AU); Zourab Brodzeli, Bondi Beach (AU)

Correspondence Address: BANNER & WITCOFF, 1001 G STREET N W, SUITE 1100, WASHINGTON, DC, 20001, US

(21) Appl. No.: 10/416,205

(22) PCT Filed: Nov. 8, 2001
(86) PCT No.: PCT/AU01/01441

(30) Foreign Application Priority Data
Nov. 8, 2000 (AU) PR1345

(51) Int. Cl. G02B 5/18; G02B 27/44

(52) U.S. Cl. 359/566

(57) ABSTRACT

An interferometer (100) for writing Bragg gratings comprising the means for splitting (112) a light beam (114) into two coherent beams (116, 118), and a first optical lens arrangement (106, 108, 110) for bringing the coherent beams to interference for writing the Bragg grating in a photosensitive material (122). The first optical lens arrangement is arraged, in use, to vary an angle β between the two interfering beams.

### FIELD OF THE INVENTION

The present invention relates broadly to an interferometer and method for writing Bragg gratings in a photosensitive material.

### BACKGROUND OF THE INVENTION

Bragg gratings have become an essential component of optical devices, in which they perform e.g. light filtering or light directing functionalities.

Typically, the writing of Bragg gratings into a photosensitive material involves an interferometer in which two coherent light beams (typically in the UV wavelength range) are being directed along separate optical paths and brought to interference substantially within the photosensitive material. Within the photosensitive material, refractive index changes are being induced through the interaction between the light beams and the photosensitive material, and refractive index profiles are being formed due to interference patterns, whereby grating structures are written.

In prior art interferometers, the bringing to interference within the photosensitive material is typically achieved utilising mirrors in the respective optical paths of the two coherent beams. The period of the interference pattern in the beams intersection is a function of the angle between the two interfering coherent beams. Mechanical vibrations of the interferometer mirrors can cause the quality of the interferogram to change over a period of time, limiting the quality of the written Bragg gratings. Furthermore, sharp focusing of the beams is also a problem encountered in such prior art interferometers, because of the “physically” different beam paths and beam pointing on the waveguide.

The present invention seeks to provide a new interferometer and method for writing Bragg gratings.

### SUMMARY OF THE INVENTION

In the summary of invention and the claims components of the same name have been identified as e.g. “first”, “second”, “third” etc. This is intended to mean “first identified”, “second identified”, “third identified” etc. rather than being intended to define a total number of the same components in individual embodiments of the invention.

In accordance with a first aspect of the present invention there is provided an interferometer for writing Bragg gratings comprising means for splitting a light beam into two coherent beams, and a first optical lens arrangement comprising at least a first optical lens arranged, in use, to bring the two coherent beams to interference for writing the Bragg grating in a photosensitive material through induced refractive index changes in the material, and wherein the first optical lens arrangement further comprises a second optical lens disposed between the means for splitting the light beam and the first optical lens, the second optical lens being arranged, in use, to vary an angle between the two coherent beams prior to the first optical lens, whereby an interference angle between the two interfering coherent beams is varied for varying a period of the resulting interference pattern.

Accordingly, the present invention can provide an interferometer for writing Bragg gratings, in which the bringing to interference of the two coherent beams is effected through an optical lens rather than through reflection at two separate mirrors, which can reduce the likelihood of perturbances during use of the interferometer, as well as in preferred embodiments provide simultaneous focusing of the beams by the same optical element(s).

In a preferred embodiment, the second optical lens is a divergent lens.

The first optical lens arrangement may further comprise a third optical lens disposed between the first and second optical lenses, the third optical lens being arranged, in use, to vary a focal length of the first arrangement.

The first optical lens arrangement may preferably further arranged in a manner such that, in use, focusing of the two interfering coherent beams in the photosensitive material.

In one embodiment, the interferometer further comprises a second optical lens arrangement comprising at least a fourth optical lens disposed, in use, along the optical path of the light beam to the means for splitting the light beam, the fourth optical lens being arranged, in use, to assist in effecting focusing of the two interfering coherent beams in the photosensitive material.

The second optical lens arrangement may further comprise a fifth optical lens disposed in the optical path of the light beam to the fourth optical lens, wherein the fourth optical lens is a convergent lens and the fifth optical lens is a divergent lens, the fourth and fifth optical lenses being arranged, in use, to transfer the image of the beam plane wavefront of the light beam to a plane within the means for splitting the beam, with the image of beam plane wavefronts transferred further to the interference region, whereby focusing of the two interfering coherent beams in the photosensitive material is facilitated. The plane within the means for splitting the beam may be the median plane within the means for splitting the beam. Where the means for splitting the beam comprises two separate beam splitting devices, the plane within the means for splitting the beam is preferably chosen in a manner such that the focusing of the two interfering coherent beams in the photosensitive material is optimised.

The means for splitting the light beam may comprise a first acousto-optic modulator, wherein the splitting of the light beam is effected through partial Bragg diffraction of the light beam in the acousto-optic modulator.

The means for splitting the light beam may comprise, but is not limited to, one or more of the group of a prism, a waveplate, a phasemask, and an arrangement comprising a semi-transparent reflection means and a further reflection means.

The interferometer further comprises a first means for shifting the frequency of a first one of the coherent beams, whereby the interferometer may be utilised to write long Bragg gratings in the photosensitive material, where relative movement between the interferometer and the material is effected.

The interferometer may further comprise a second means for shifting the frequency of the second coherent beam. Preferably, the second means for shifting the frequency of the second coherent beam is arranged, in use, to shift the frequency of the second coherent beam in a direction equal to that of the first means for shifting the frequency of the first coherent beam.

The interferometer may further comprise a third means for shifting the frequency of the first coherent beam. Preferably, the third means is arranged, in use, to shift the frequency of the first coherent beam in a direction opposite to that of the first means for shifting, the frequency of the first coherent beam.

The second and/or third means for shifting the frequencies may comprise acousto-optic modulators, wherein the shifting the frequencies is effected through Bragg diffraction of the beams in the acousto-optic modulator.

The means for splitting the light beam may incorporate the first means for shifting the frequency of the first coherent beam and/or the second means for shifting the frequency of the second coherent beam.

The means for splitting the light beam may alternatively incorporate the first means for shifting the frequency of the first coherent beam and/or the third means for shifting the frequency of the first coherent beam.

Advantageously, the first and/or the second optical lens arrangements, may further comprise means for reducing or eliminating aberrations experienced, in use, by the first and/or second coherent beams. The means for eliminating aberrations may comprise a combination of biconcave and plane-convex lenses for the first and/or the second optical lens arrangements.

The photosensitive material may comprise an optical waveguide. The optical waveguide may be in the form of an optical fibre or a planar waveguide.

In accordance with a second aspect of the present invention there is provided a method of writing Bragg gratings comprising the steps of splitting a light beam into two coherent beams, and bringing the coherent beams to interference for writing the Bragg grating in a photosensitive material through induced refractive index changes in the material, wherein the step of bringing the coherent beams to interference is conducted utilising at least one optical lens, wherein the method further comprise the step of varying an interference angle between the two interfering coherent beams utilising a second optical lens disposed between a spitting point of the two coherent beams and the first optical lens, for varying a period of the resulting interference pattern.

Preferably, the optical lens arrangement further comprises a second optical lens disposed between a means for splitting the light beam and the first optical lens, and the second optical lens is used to vary an angle between the two coherent beams prior to the first optical lens to vary the angle between the interfering beams. In a preferred embodiment, the second optical lens is a divergent lens.

The method may further comprise the step of varying a focal length of the first optical lens arrangement. Preferably, the first optical lens arrangement further comprises a third optical lens disposed between the first and second optical lenses, and the third optical lens is used to vary the focal length.

The method may further comprise the step of focusing the two interfering beams in the photosensitive material. Preferably, a second optical lens arrangement comprising at least a fourth optical lens disposed along the optical path of the light beam to the means for splitting the light beam is utilised, the fourth optical lens being used to assist effecting the focusing.

The method may further comprise the step of transferring the image of the beam plane wavefront of the light beam to a plane within the means for splitting the beam, whereby focusing of the two interfering coherent beams in the photosensitive material is facilitated. Preferably, the second optical lens arrangement further comprises a fifth optical lens disposed in the optical path of the light beam to the fourth optical lens, wherein the fourth optical lens is a convergent lens and the fifth optical lens is a divergent lens, and the fourth and fifth optical lenses are used to transfer the image of the beam plane wavefront of the light beam, and further to the interference region in the photosensitive material. The plane within the means for splitting the beam may be the median plane within the means for splitting the beam. Where the means for splitting the beam comprises two separate beam splitting devices, the plane within the means for splitting the beam is preferably chosen in a manner such that the focusing of the two interfering coherent beams in the photosensitive material is optimised.

The step of splitting the light beam may comprise utilising a first acousto-optic modulator, wherein the splitting of the light beam is effected through partial Bragg diffraction of the light beam in the acousto-optic modulator.

The step of splitting the light beam may comprise, but is not limited to, utilising one or more of the group of a prism, a waveplate, a phasemask, and an arrangement comprising a semi-transparent reflection means and a further reflection means.

The method may further comprise the step of shifting the frequency of a first one of the coherent beams, whereby the long Bragg gratings can be written in the photosensitive material, where relative movement between the interfering region and the material is effected.

In such embodiments, the method may further comprise the step of shifting the frequency of the second coherent beam. Preferably, the frequency of the second coherent beam is shifted in a direction equal to that in which the frequency of the first coherent beam is shifted

The method may alternatively further comprise the step of further shifting the frequency of the first coherent beam. Preferably, the further shifting of the frequency of the first coherent beam occurs in a direction opposite to that of the initial shifting of the frequency of the first coherent beam.

The shifting of the frequencies may comprise utilising acousto-optic modulators, wherein the shifting of the frequencies is effected through Bragg diffraction of the beams in the acousto-optic modulator.

Advantageously, the method further comprises the step of reducing or eliminating aberrations experienced by the first and/or second coherent beams. The method may comprise utilising a combination of bi-concave and plane-convex optical lenses for reducing or eliminating the aberrations.

The photosensitive material may comprise an optical waveguide. The optical waveguide may be in the form of an optical fibre or a planar waveguide.

Preferred forms of the present invention will now be described, by way of example only, with reference to the accompanying drawings.

### BRIEF DESCRIPTION OF THE DRAWINGS

FIG. 1 is a schematic drawing illustrating an interferometer embodying the present invention.

FIG. 2 is a schematic drawing illustrating another interferometer embodying the present invention.

FIG. 3 is a schematic drawing illustrating another interferometer embodying the present invention.

FIG. 4 is a schematic drawing illustrating another interferometer embodying the present invention.

### DETAILED DESCRIPTION OF THE EMBODIMENTS

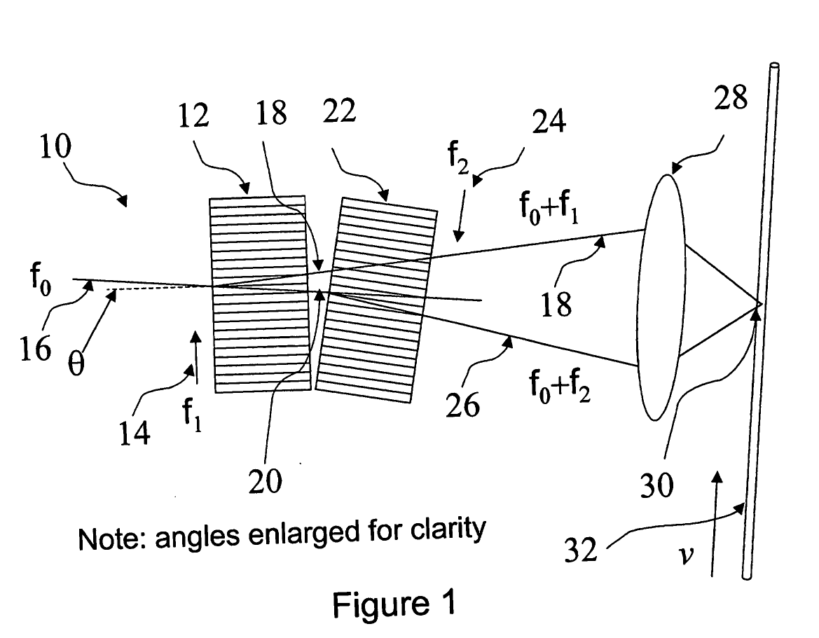

In FIG. 1, the interferometer 10 comprises a first acousto-optic modulator 12 being operated under an acoustic wave of a first frequency f₁, as indicated by arrow 14. An incoming light beam 16 is incident on the acousto-optic modulator 12 under a first order Bragg angle θ. The operating conditions of the acousto-optic modulator 12 are chosen such that the modulator 12 is under-driven, whereby approximately 50% of the incoming beam 16 is diffracted into a first order diffraction beam 18, and 50% passes through the acousto-optic modulator 12 as un-diffracted beam 20. The un-diffracted beam 20 is incident on a second acousto-optic modulator 22 of the interferometer 10 under a first order Bragg angle, whereas the beam 18 is not. Accordingly, the beam 18 passes through the second acousto-optic modulator 22 without any significant loss.

The second acousto-optic modulator 22 is operated under an acoustic wave of a frequency f₂=f₁+Δf which propagates in a direction opposed to the direction of the acoustic wave in the first modulator 12, as indicated by arrow 24. After the second acousto-optic modulator the first order diffracted beam 26 and the beam 18 are frequency shifted in the same direction (in the example embodiment higher frequency), but by different amounts, ie f₁ versus f₂.

The beams 18, 26 are then brought to interference utilising an optical lens 28, and the resultant interference (at numeral 30) induces refractive index changes in a photosensitive optical fibre 32, whereby a refractive index profile, ie grating structure, is created in the optical fibre 32.

In the embodiment shown in FIG. 1, the optical fibre is translated through the interference region 30 at a speed chosen such that a long grating structure can be written, utilising a moving interference pattern which is being moved as a result of the modulation of beams 18, 26. The speed of translation of the optical fibre 32 is matched to the “speed” of the interference pattern change, whereby a continuous grating structure can be written into optical fibre 32. This technique is sometimes referred to as the “running light” effect.

The velocity of the interference pattern change is given by:

v=Λ_{1P}(f₂−f₁)=Λ_{1P}Δf [1]

where Λ_{1P} is the period of the interference pattern, which depends, inter alia, on the angle between the two coherent beams 18, 26 at numeral 30. When the speed of translation of the optical fibre 32 and the “speed” of the interference pattern change are matched, the period of the written grating Λ_{FBG} is equal to the period of the interference pattern Λ_{1P}, as given by equation [1]. It is noted that where f₂=f₁ is chosen, the interferometer 10 may be used to write short gratings in stationary fibre compared to the case of movement between the optical fibre 32 and the interference region 30.

In an alternative embodiment, the two acousto-optic modulators 12, 22 may be replaced by one acousto-optic modulator arranged to be operated made a complex 2-D acoustic field.

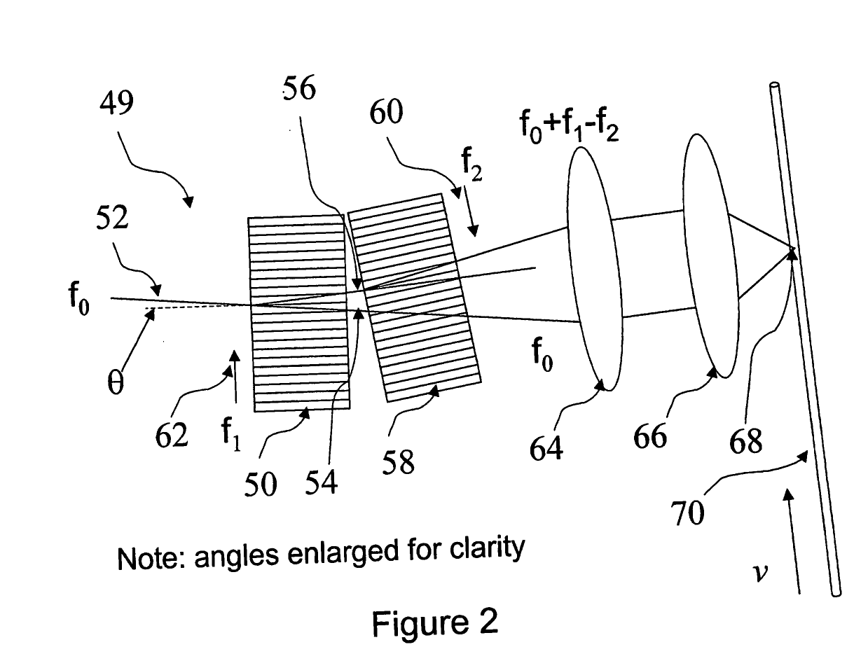

In FIG. 2, in another embodiment the interferometer 49 comprises a first acousto-optic modulator 50 for splitting an incoming beam 52 into two coherent beams 54, 56. Simultaneously, the modulator 50 shifts the frequency of the diffracted one of the coherent beams 56, the modulator 50 being under-driven and operated under an acoustic wave of a frequency f₁.

The interferometer 49 further comprises a second acousto-optic modulator 58 which is operated under an acoustic wave of a frequency f₂=f₁+Λf, which propagates in a direction substantially opposed to the direction of the acoustic wave in the first modulator 50, as indicated by arrows 60 and 62 respectively. The second coherent beam 54 is not incident on the modulator 58 under a Bragg angle, whereby the second coherent beam 54 propagates through the modulator 58 without being diffracted or frequency shifted. After the second modulator 58, the frequency of the first coherent beam 50 is f₀+f₁−f₂=f₀−Δf, whereas the frequency of the second coherent beam 54 remains at f₀. Again, where f₂=f₁ is chosen, the interferometer 49 may be used to write short gratings in stationary fibre compared to the case of movement between the optical fibre 70 and the interference region 68.

The interferometer 49 further comprises two optical lenses 64, 66 for bringing the two coherent beams 56, 54 to interference at a region 68 substantially within a photosensitive optical fibre 70 which is being translated through the interference region 68. It will be appreciated by a person skilled in the art that the optical lens arrangement comprising optical lenses 64, 66 allows the changing the focal length of that arrangement.

In an alternative embodiment, the two acousto-optic modulators 50, 58 may be replaced by one acousto-optic modulator arranged to be operated simultaneously under the different acoustic waves 62, 60.

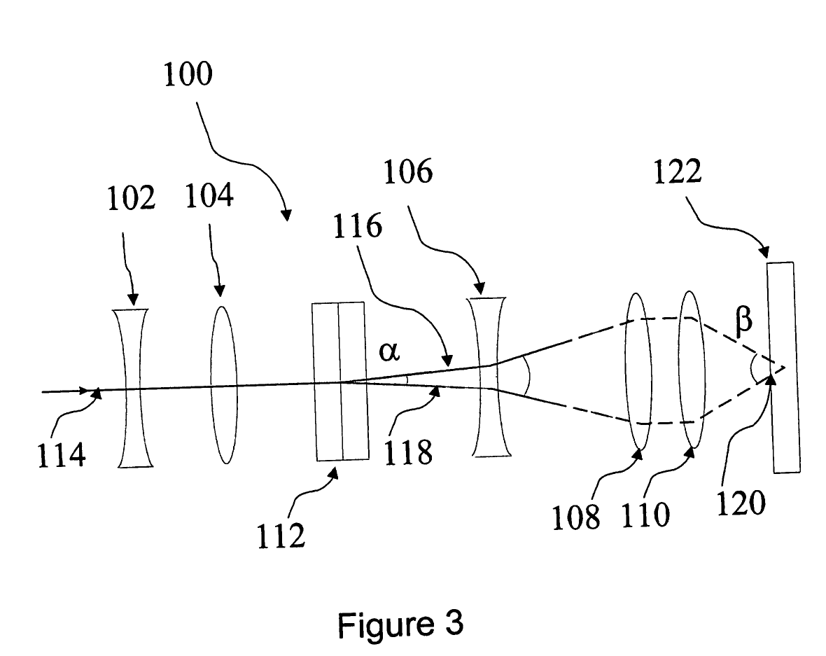

In another embodiment illustrated in FIG. 3 an interferometer 100 comprises a set of five lenses 102, 104, 106, 108 and 110 respectively. The interferometer 100 further comprises an acousto-optic beam splitter arrangement 112 disposed between optical lenses 104 and 106.

The beam splitter arrangement 112 splits a Gaussian laser beam 114 into two coherent beams 116, 118 separated by an angle α.

The set of five optical lenses 102, 104, 106, 108 and 110 can be divided into two groups. The first group, comprising optical lenses 106, 108 and 110 form a required angle β between the two coherent beams 116, 118 in the beam intersection region 120 in a photosensitive optical waveguide in the form of an optical fibre 122. The angle is denoted β, and the relationship between β and Λ_{1P} is given by:

$$β = 2 arcsin ( {λ}_{UV} / 2 {Λ}_{IP} ) or {Λ}_{IP} = \frac{{λ}_{UV}}{2 sin ( \frac{β}{2} )} \qquad [ 2 ]$$

where λ_{UV} is the wavelength of the light beams, Λ_{1P} is the period of the interference pattern in the fibre. As can be seen from relationship [2], changing the angle β between the two interfering beams 116, 118, one can change the period Λ_{1P} of the interference pattern in the optical fibre 122. The angle β can be varied through movement of optical lens 106. Simultaneously, the focal length of the arrangement comprising optical lenses 108, 110 can be changed through movement of optical lens 108, whereby the distance between optical lens 110 and the point of interference at numeral 120 can be maintained constant. Thus, the period can be varied “internally” within the interferometer 100, rather than changing the overall geometry between the optical fibre 122 and the final lens 110 of the interferometer 100.

It will be appreciated by the person skilled in the art that accordingly the interferometer 100 can be used to write grating structures of varying period and/or varying amplitude into the optical fibre 122. The interferometer 100 may be used in a static configuration to write short gratings of the size of the interference region 120, or in a dynamic setup (compare embodiments described above with reference to FIGS. 1 and 2), to write long grating structures of varying period and/or varying amplitude. In the dynamic setup, the speed of translation of the optical fibre 122 and the “speed” of the interference pattern change are preferably synchronised by varying either the speed of translation of the optical fibre 122 or the difference in frequencies between the two coherent beams. This ensures that the period of the written fibre Bragg grating AFBR is equal to the (changed) period of the interference pattern Λ_{1P}.

The second group of optical lenses in the interferometer 100 comprises optical lenses 102 and 104, disposed in the optical path of the laser beam 114 before the beam splitter 112.

In the exemplary embodiment shown in FIG. 3, optical lens 102 is a divergent lens, whereas optical lens 104 is a convergent lens. Optical lenses 102 and 104 are arranged in a manner such that, in use, they transfer the image of the beam plane wavefront to a plane 124 within the beam splitter arrangement 112, and further to the plane in the interference region 120. Where the beam splitter and shifting arrangement 112 comprises two acousto-optic modulators (compare embodiments described above with reference to FIGS. 1 and 2), the position of the plane 124 within the beam splitter arrangement is preferably chosen in a manner such that optimal focusing in the beam interference region 120 within the optical fibre 122 is achieved.

It will be appreciated by the person skilled in the art that the second group of optical lenses may in alternative embodiments include two convergent lenses or a convergent lens followed by a divergent lens. In selecting a group most suitable for a particular application, consideration will be given, inter alia, to light intensities within the interferometer on the one hand, and aberrations of the beams on the other hand.

The embodiment shown in FIG. 3 has four key advantages as follows:

the system is suitable for setting of the period of the interference pattern in the fibre.

the two coherent beams pass the same optical elements and travel equal paths, which increases the quality of the interference.

the interferometer design is good for both high- and low-coherent beams.

the beams can be focused in the optical fibre with very high ratio resulting in increasing power of about 10⁴ to 10⁶ times compared to unfocused beams, which facilitates improved induction of refractive index changes in the photosensitive material during the writing of grating structures.

It will be appreciated that the interferometer 100 shown in FIG. 3 can be used to write short or long grating structures through suitable disposition/operation of the acousto-optic beam splitter arrangement 112, similar to the embodiments described above with reference to FIGS. 1 and 2.

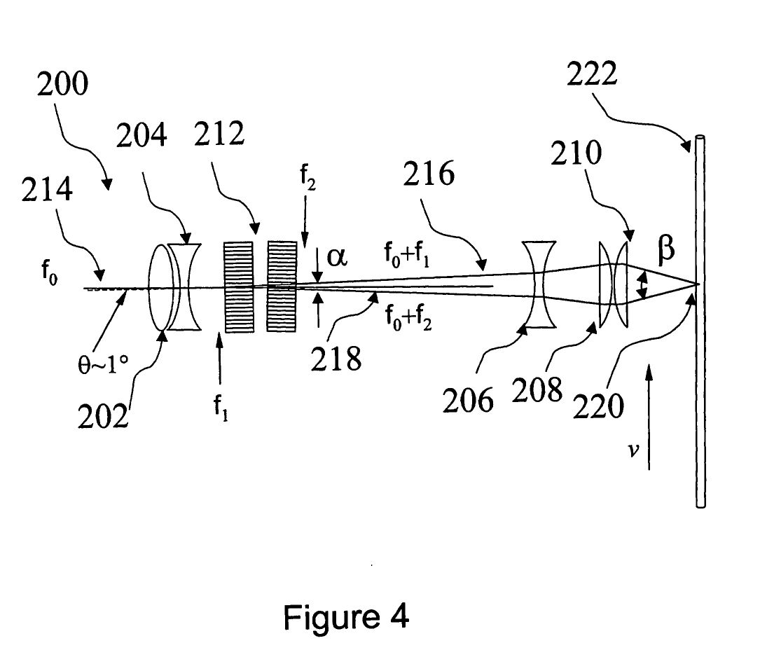

Turning now to FIG. 4, another interferometer 200 comprises a set of five lenses 202, 204, 206, 208 and 210 respectively. The interferometer 200 further comprises an acousto-optic beam splitter arrangement 212 disposed between the optical lenses 204 and 206.

The beam splitter arrangement 212 splits a Gaussian laser beam 214 into two coherent beams 216, 218 separated by an angle α.

The set of five optical lenses 202, 204, 206, 208 and 210 can be divided into two groups. The first group, comprising optical lenses 206, 208, and 210 form a required angle β between the two coherent beams 216, 218 in the beam interference region 220 in a photosensitive optical waveguide in the form of an optical fibre 222.

In the example embodiment shown in FIG. 4, the optical lens 206 is a bi-concave lens, whereas the lenses 208 and 210 are plane-convex lenses, with the convex sides of the lenses 208, 210 facing each other.

It will be appreciated by the person skilled in the art that the parameters of the optical lenses 206, 208 and 210 can be chosen in manner such that the coherent beams 216, 218 (i.e. off-axis beams) do not experience any spherical aberration effects. In other words, when lenses 206 and 208 are moved to adjust the angle β at the beam intersection region 220 (compare description of interferometer 100 above in conjunction with FIG. 3B), the adjustment of the position of lens 208 does not have to take into account spherical aberration effects.

The second group of optical lenses in the interferometer 200 comprises optical lenses 202, and 204 disposed in the optical path of the laser beams 214 before the beam splitter 212. Similar to the interferometer 100 described above with reference to FIG. 3, the optical lenses 202 and 204 are utilised to assist, in conjunction with the first group, achieving optimal focusing in the beam interference region 220 within the optical fibre 222.

For further details on utilisation of acousto-optic modulators in interferometers for writing Bragg gratings, reference is made to an International Patent Cooperation Treaty (PCT) application entitled “Interferometer for writing Bragg gratings”, in the name of Redfern Optical Components Pty Ltd, filed on the same day as the present application, and to a PCT application entitled “Control of grating period”, in the name of Redfern Optical Components Pty Ltd, also filed on the same day as the present application, the contents of which are hereby incorporated by cross-reference.

It will be appreciated by the person skilled in the art that numerous variations and/or modifications may be made to the present invention as shown in the specific embodiment without departing from the spirit or scope of the invention as broadly described. The present embodiments are, therefore, to be considered in all respects to be illustrative and not restrictive.

For example, it will be appreciated that through appropriate control of the acousto-optic modulators in embodiments of the present invention various types of long grating structures may be written in photosensitive materials. Grating structures of various phase and/or amplitude profiles that may be written do include continuous gratings of constant amplitude and period, consecutive gratings of varying amplitude or period in a single waveguide, chirped gratings, apodised grating structures, sampled gratings, superstructural gratings, and grating structures comprising a periodic arrangement of grating portions, wherein the period of each individual grating portion and/or the period in which the grating portions are arranged with respect to each other may further be chirped.

Furthermore, it will be appreciated that the present invention is not limited to the use of an acousto-optic modulator for effecting the beam splitting. Rather, the present invention is equally applicable to interferometers where the splitting is effected through other means, including through one or more of the group of a prism, a waveplate, a phasemask, and an arrangement comprising a semi-transparent reflection means and a further reflection means.

In yet another embodiment of the present invention, cylindrical lenses may be utilised. In such embodiments, the longitudinal axis of the cylindrical lenses is preferably disposed perpendicular to the central axis of the optical fibre. Such embodiments can have the advantage of ensuring a tightly focused beam interference in a direction along the central axis of the optical fibre, while in a direction perpendicular to the central axis substantially no focusing occurs, i.e. substantially no intensity variations in the interference pattern occur along the width of the core of the optical fibre.

In the claims that follow and in the summary of the invention, except where the context requires otherwise due to express language or necessary implication, the word “comprising” is used in the sense of “including”, i.e. the feature specified may be associated with further features in various embodiments of the invention.

1. An interferometer for writing Bragg gratings comprising:
means for splitting a light beam into two coherent beams,
a first optical lens arrangement comprising at least a first optical lens arranged, in use, to bring the two coherent beams to interference for writing the Bragg grating in a photosensitive material through induced refractive index changes in the material, and
wherein the first optical lens arrangement further comprises a second optical lens disposed between the means for splitting the light beam and the first optical lens, the second optical lens being arranged, in use, to vary an angle between the two coherent beams prior to the first optical lens, whereby an interference angle between the two coherent beams is varied for varying a period of the resulting interference pattern.

2. An interferometer as claimed in claim 1, wherein the second optical lens is a divergent lens.

3. An interferometer as claimed in claims 1 or 2, wherein the first optical lens arrangement further comprises a third optical lens disposed between the first and second optical lenses, the third optical lens being arranged, in use, to vary a focal length of the first arrangement.

4. An interferometer as claimed in any one of claims 1 to 3, wherein the first optical lens arrangement is further arranged to effect focusing of the two interfering coherent beams in the photosensitive material.

5. An interferometer as claimed in any one of the preceding claims, wherein the interferometer further comprises a second optical lens arrangement comprising at least a fourth optical lens disposed, in use, along the optical path of the light beam to the means for splitting the light beam, the fourth optical lens being arranged, in use, to assist effecting focusing of the two interfering coherent beams in the photosensitive material.

6. An interferometer as claimed in claim 6, wherein the second optical lens arrangement further comprises a fifth optical lens disposed in the optical path of the light beam to the fourth optical lens, wherein the fourth optical lens is a convergent lens and the fifth optical lens is a divergent lens, the fourth and fifth optical lenses being arranged, in use, to transfer the image of the beam plane wavefront of the light beam to a plane within the means for splitting the beam and further to the interference region, whereby focusing of the two interfering coherent beams in the photosensitive material is facilitated.

7. An interferometer as claimed in claim 6, wherein the plane within the means for splitting the beam is the median plane within the means for splitting the beam.

8. An interferometer as claimed in claim 6, wherein, where the means for splitting the beam comprises two separate beam splitting devices, the plane within the means for splitting the beam is chosen in a manner such that the focusing of the two interfering coherent beams in the photosensitive material is optimised.

9. An interferometer as claimed in any one of the preceding claims, wherein the means for splitting the light beam comprises a first acousto-optic modulator, wherein the splitting of the light beam is effected through partial Bragg diffraction of the light beam in the acousto-optic modulator.

10. An interferometer as claimed in any one of the preceding claims, wherein the means for splitting the light beam comprises one or more of the group of a prism, a waveplate, a phasemask, and an arrangement comprising a semi-transparent reflection means and a further reflection means.

11. An interferometer as claimed in any one of the preceding claims, wherein the interferometer further comprises a first means for shifting the frequency of a first one of the coherent beams, whereby the interferometer is utilised to write long Bragg gratings in the photosensitive material, where relative movement between the interferometer and the material is effected.

12. An interferometer as claimed in claim 11, wherein the interferometer further comprises a second means for shifting the frequency of the second coherent beam.

13. An interferometer as claimed in claim 12, wherein the second means for shifting the frequency of the second coherent beam is arranged, in use, to shift the frequency of the second coherent beam in a direction equal to that of the first means for shifting the frequency of the first coherent beam.

14. An interferometer as claimed in claim 11, wherein the interferometer further comprises a third means for shifting the frequency of the first coherent beam.

15. An interferometer as claimed in claim 14, wherein the third means is arranged, in use, to shift the frequency of the first coherent beam in a direction opposite to that of the first means for shifting, the frequency of the first coherent beam.

16. An interferometer as claimed in any one of claims 12 to 15, wherein the second and/or third means for shifting the frequencies comprise acousto-optic modulators, wherein the shifting the frequencies is effected through Bragg diffraction of the beams in the acousto-optic modulator.

17. An interferometer as claimed in claims 11, 12 or 13, wherein the means for splitting the light beam incorporates the first means for shifting the frequency of the first coherent beam and/or the second means for shifting the frequency of the second coherent beam.

18. An interferometer as claimed in claims 11, 14 or 15, wherein the means for splitting the light beam incorporates the first means for shifting the frequency of the first coherent beam and/or the third means for shifting the frequency of the first coherent beam.

19. An interferometer as claimed in any one of the preceding claims, wherein the first and/or the second optical lens arrangements, further comprises means for reducing or eliminating aberrations experienced, in use, by the first and/or second coherent beams.

20. An interferometer as claimed in claim 19, wherein the means for reducing or eliminating aberrations comprises a combination of bi-concave and plane-convex optical lenses for the first and/or the second optical lens arrangements.

21. An interferometer as claimed in any one of the preceding claims, wherein the photosensitive material comprises an optical waveguide.

22. An interferometer as claimed in claim 21, wherein the optical waveguide is in the form of an optical fibre or a planar waveguide.

23. A method of writing Bragg gratings comprising the steps of
splitting a light beam into two coherent beams,
bringing the coherent beams to interference for writing the Bragg grating in a photosensitive material through induced refractive index changes in the material,
wherein the step of bringing the coherent beams to interference is conducted utilising a at least one optical lens, and
wherein the method further comprises the step of varying an interference angle between the two coherent beams utilising a second optical lens disposed between a splitting point of the two coherent beams and the first optical lens, for varying a period of the resulting interference pattern.

24. A method as claimed in claim 23, wherein the optical lens arrangement further comprises a second optical lens disposed between a means for splitting the light beam and the first optical lens, and the second optical lens is used to vary an angle between the two coherent beams prior to the first optical lens to vary the angle between the interfering coherent beams.

25. A method as claimed in claim 24, wherein the second optical lens is a divergent lens.

26. A method as claimed in any one of claims 23 to 25, wherein the method further comprises the step of varying a focal length of the first optical lens arrangement.

27. A method as claimed in claim 26, wherein the first optical lens arrangement further comprises a third optical lens disposed between the first and second optical lenses, and the third optical lens is used to vary the focal length.

28. A method as claimed in any one of claims 23 to 27, wherein the method further comprises the step of focusing the two interfering beams in the photosensitive material.

29. A method as claimed in claim 28, wherein a second optical lens arrangement comprising at least a fourth optical lens disposed along the optical path of the light beam to the means for splitting the light beam is utilised, the fourth optical lens being used to assist effecting the focusing.

30. A method as claimed in any one of claims 23 to 29, wherein the method further comprises the step of transferring the image of the beam plane wavefront of the light beam to a plane within the means for splitting the beam, whereby focusing of the two interfering coherent beams in the photosensitive material is facilitated.

31. A method as claimed in claim 30, wherein the second optical lens arrangement further comprises a fifth optical lens disposed in the optical path of the light beam to the fourth optical lens, wherein the fourth optical lens is a convergent lens and the fifth optical lens is a divergent lens, and the fourth and fifth optical lenses are used to transfer the image of the beam plane wavefront of the light beam and further to the interference region.

32. A method as claimed in claim 31, wherein the plane within the means for splitting the beam is the median plane within the means for splitting the beam.

33. A method as claimed in claim 32, wherein, where the means for splitting the beam comprises two separate beam splitting devices, the plane within the means for splitting the beam is chosen in a manner such that the focusing of the two interfering coherent beams in the photosensitive material is optimised.

34. A method as claimed in any one of claims 23 to 33, wherein the step of splitting the light beam comprises utilising a first acousto-optic modulator, wherein the splitting of the light beam is effected through partial Bragg diffraction of the light beam in the acousto-optic modulator.

35. A method as claimed in any one of claims 23 to 34, wherein the step of splitting the light beam comprises utilising one or more of the group of a prism, a waveplate, a phasemask, and an arrangement comprising a semi-transparent reflection means and a further reflection means.

36. A method as claimed in any one of claims 23 to 35, wherein the method further comprises the step of shifting the frequency of a first one of the coherent beams, whereby the long Bragg gratings can be written in the photosensitive material, where relative movement between the interfering region and the material is effected.

37. A method as claimed in claim 36, wherein the method further comprises the step of shifting the frequency of the second coherent beam.

38. A method as claimed in claim 37, wherein the frequency of the second coherent beam is shifted in a direction equal to that in which the frequency of the first coherent beam is shifted

39. A method as claimed in claim 38, wherein the method further comprise the step of further shifting the frequency of the first coherent beam.

40. A method as claimed in claim 39, wherein the further shifting of the frequency of the first coherent beam occurs in a direction opposite to that of the initial shifting of the frequency of the first coherent beam.

41. A method as claimed in any one of claims 36 to 40, wherein the shifting of the frequencies comprises utilising acousto-optic modulators, wherein the shifting the frequencies is effected through Bragg diffraction of the beams in the acousto-optic modulators.

42. A method as claimed in any one of claims 23 to 41, wherein the method further comprises the step of reducing or eliminating aberrations experienced by the first and/or second coherent beams.

43. A method as claimed in claim 42, wherein the method comprises the step of utilising a combination of bi-concave and plane-convex optical lenses for reducing or eliminating the aberrations.

44. A method as claimed in any one of claims 23 to 43, wherein the photosensitive material comprise an optical waveguide.

45. A method as claimed in claim 44, wherein the optical waveguide is in the form of an optical fibre or a planar waveguide.
